(19) United States
(12) Patent Application Publication
(10) Pub. No.: US 2021/0301094 A1
(43) Pub. Date: Sep. 30, 2021

(54) MANUFACTURING METHOD OF FIBER REINFORCED RESIN MOLDED PRODUCT

(71) Applicant: TOYOTA JIDOSHA KABUSHIKI KAISHA, Toyota-shi (JP)

(72) Inventor: Ken HATTA, Toyota-shi (JP)

(73) Assignee: TOYOTA JIDOSHA KABUSHIKI KAISHA, Toyota-shi (JP)

(21) Appl. No.: 17/197,141

(22) Filed: Mar. 10, 2021

(30) Foreign Application Priority Data
Mar. 24, 2020 (JP) 2020-053217

(51) Int. Cl. C08J 5/04

(52) U.S. Cl. CPC C08J 5/043; C08J 2487/00; C08J 2387/00

(57) ABSTRACT

A manufacturing method of a fiber reinforced resin molded product including: supplying a first resin composition to the fiber layer; and supplying a second resin composition to the fiber layer, after supplying the first resin composition to the fiber layer, in which a curing start temperature of the first resin composition is higher than a curing start temperature of the second resin composition.

### CROSS-REFERENCE TO RELATED APPLICATION

This application claims priority to Japanese Patent Application No. 2020-053217 filed on Mar. 24, 2020 incorporated herein by reference in its entirety.

### BACKGROUND

### 1. Technical Field

The present disclosure relates to a method for manufacturing a molded product (fiber reinforced resin molded product) reinforced by a fiber layer impregnated with resin.

### 2. Description of Related Art

For example, a high-pressure tank for a fuel cell vehicle has a liner that forms an internal space of the high-pressure tank, and high strength is realized by disposing a fiber layer impregnated with resin on the outer periphery of the liner. Further, not limited to the high-pressure tank for the fuel cell vehicle, a fiber layer impregnated with resin may be disposed in order to realize high strength.

Japanese Unexamined Patent Application Publication No. 2019-056415 (JP 2019-056415 A) discloses a method for manufacturing a high-pressure tank, in which a preform having a fiber layer formed on an outer surface of a liner forming an internal space of the high-pressure tank is disposed in a mold, and the fiber layer is impregnated with resin by rotating the preform in the mold with the a central axis of the preform as a rotation center while injecting resin toward the preform disposed in the mold.

### SUMMARY

When impregnating the fiber layer with resin, it may be difficult to uniformly impregnate resin depending on the thickness and shape of the layer. If resin is injected at a high pressure, the pressure causes deformation of the object to be molded, or the equipment becomes large-scale. Further, it cannot be said that sufficient impregnation is possible even if the fiber layer is rotated during impregnation. In particular, since the high-pressure tank for a fuel cell vehicle has a thick fiber layer in order to secure the strength and the shape is a cylindrical shape that is long in the axial direction, the above problem is more prominent.

In contrast, the above problem may be alleviated by taking time to impregnate and cure the fiber layer by adjusting the temperature for example, but there is a problem that productivity is lowered. Further, if a resin that cures quickly is impregnated at a high pressure for productivity, a large-scale device as described above may be required or the molded product may be deformed.

The present disclosure provides a manufacturing method of a fiber reinforced resin molded product, in which a fiber layer can be impregnated at a high-quality while suppressing a decrease in productivity.

An aspect of the present disclosure is a manufacturing method of a fiber reinforced resin molded product including impregnating a fiber layer with resin, the manufacturing method including: supplying a first resin composition to the fiber layer; and supplying a second resin composition to the fiber layer, after supplying the first resin composition to the fiber layer, in which a curing start temperature of the first resin composition is higher than a curing start temperature of the second resin composition. Here, the “curing start temperature” means the temperature at which the polymerization reaction starts and a rapid temperature rise occurs.

A mold may be used for impregnating the fiber layer with the resin, and the temperature of the mold may be set lower than the curing start temperature of the first resin composition and higher than the curing start temperature of the second resin composition.

The supply amount of the first resin composition may be 50% by mass or more and 67% by mass or less with respect to a total supply amount of the first resin composition and the second resin composition.

In both the first resin composition and the second resin composition, curing may be started by a main agent and a curing agent being mixed, and the main agent of the first resin composition and the second resin composition may be the same material.

According to the manufacturing method of a fiber reinforced molded product of the present disclosure, when a fiber layer is impregnated with resin, the fiber layer can be impregnated at a high quality while a decrease in productivity is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is an exploded view illustrating a mold 20 and a preform 10;

FIG. 1B is a combination of the mold 20 and the preform 10;

FIG. 2 is a diagram illustrating the configuration and relationship of an impregnation device 30, the mold 20, and the preform 10;

FIG. 3 is a diagram illustrating the flow of a manufacturing method S10 of a fiber reinforced resin molded product;

FIG. 4 is a diagram illustrating a step S11 of installation in a mold and deaeration;

FIG. 5 is a diagram illustrating a step S12 of starting and stopping a primary injection;

FIG. 6 is a diagram illustrating a step S13 of changing to an unloading state;

FIG. 7 is a diagram illustrating a step S14 of starting a secondary injection; and

FIG. 8 is a diagram illustrating a step S15 of changing to a fastened state.

### DETAILED DESCRIPTION OF EMBODIMENTS

### Manufacturing Equipment for Fiber Reinforced Resin Molded Product

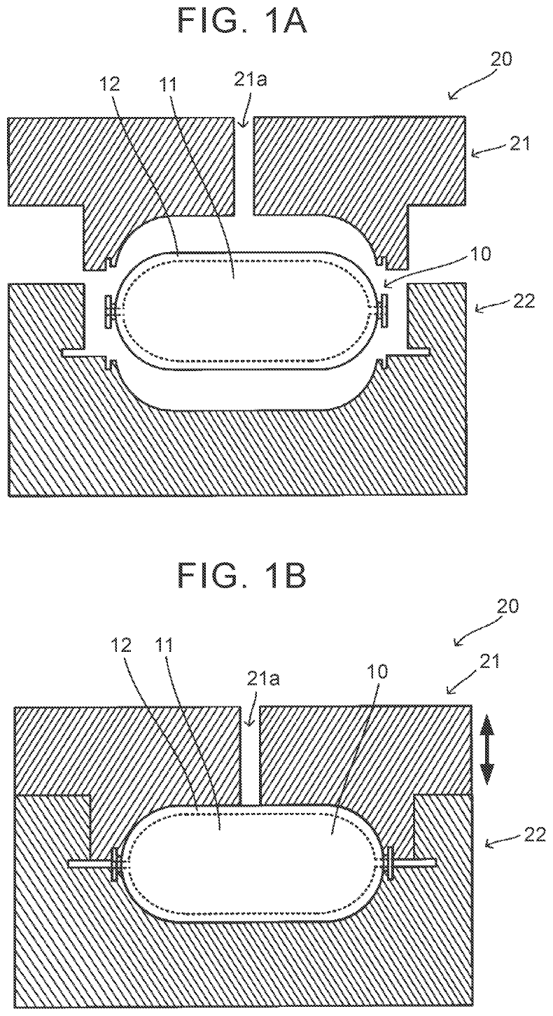

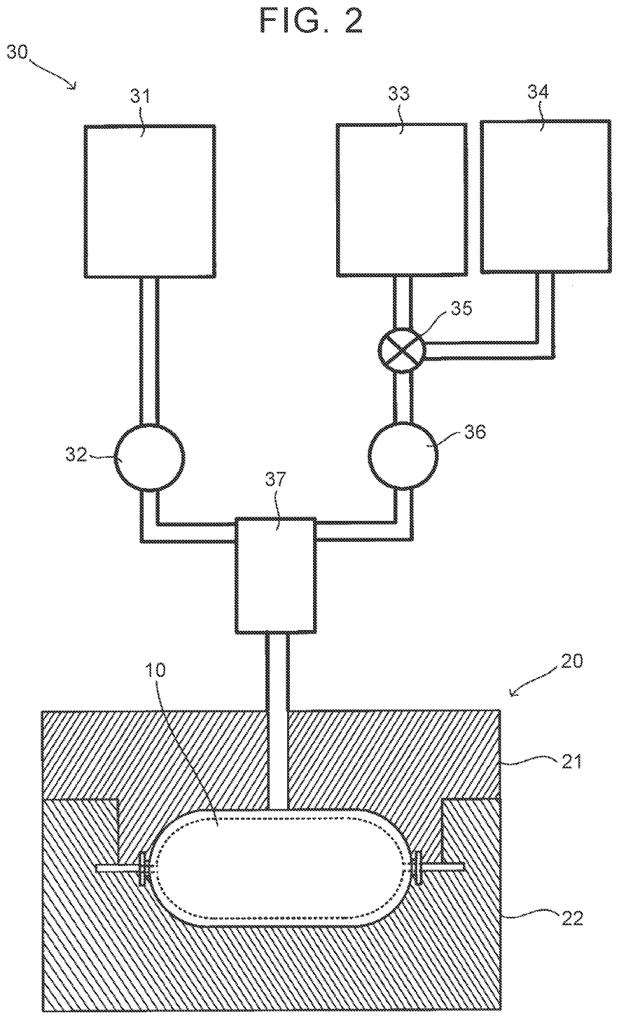

In FIG. 1A and FIG. 1B, the preform 10 that is a molding object and the mold 20 for impregnating the resin into the preform 10 are shown schematically. In FIGS. 1A and 1B, the mold 20 is represented by a cross section, the preform 10 is represented by a surface rather than a cross section, and an inner form thereof is represented by a broken line. FIG. 1A is an exploded view of the mold 20 and the preform 10. FIG. 1B is a diagram illustrating a state in which the preform 10 is installed in the mold 20. FIG. 2 schematically shows a device for impregnation (impregnation device 30). As can be seen from the following description, the present disclosure is related to a fiber reinforced resin molded product of a so-called resin transfer molding (RTM) in which a fiber layer provided in a preform is impregnated with resin composition and then cured to form a reinforcing layer.

Preform

The preform 10 is an intermediate member that eventually becomes a high-pressure tank, which is one aspect of the fiber reinforced resin molded product, and is configured to have at least a liner 11 and a fiber layer 12. The present embodiment is a high-pressure tank for fuel cell vehicles among high-pressure tanks.

The liner 11 is a hollow member that defines the internal space of the high-pressure tank. The liner may be made of a material that can hold what is contained in the internal space without leaking, and a known material can be used. For example, nylon resin, polyethylene-based synthetic resin, or metal such as stainless steel.

The fiber layer 12 is a layer in which fibers are wound around the outer surface of the liner 11 in multiple layers to a predetermined thickness. The thickness of the fiber layer 12 is determined by the required strength and is not particularly limited, but is set to a thickness of about 10 mm to 30 mm. In particular, in a high-pressure tank for a fuel cell vehicle, it is necessary to form a thick fiber layer in order to secure the strength, which is highly difficult from the viewpoint of impregnating the fiber layer with resin. Among the fiber layers, the liner 11 side may be described as an “inner layer side”, and the side opposite to the liner 11 side may be described as an “outer layer side”. Carbon fibers are used as the fibers. More specifically, the fibers are a carbon fiber bundle that has a strip shape in which the carbon fibers form a bundle with a predetermined cross-sectional shape (for example, a rectangular cross section). The fiber layer is formed by wrapping such a carbon fiber bundle around the outer surface of the liner. Further, winding of the fibers (bundle) around the outer surface of the liner 11 is performed by a filament winding method or the like, for example.

The fiber layer 12 of such a preform 10 is impregnated with resin. Further, if necessary, a protective layer made of glass fiber is further formed on the outer periphery thereof to form a high-pressure tank.

Mold

The mold 20 is a mold for impregnating the fiber layer 12 of the preform 10 with resin, and is configured to have an upper mold 21 and a lower mold 22 in the present embodiment. By overlapping the upper mold 21 and the lower mold 22, an internal space that follows the shape of the preform 10 is formed inside the mold 20. This internal space can be evacuated and can form a sealed space.

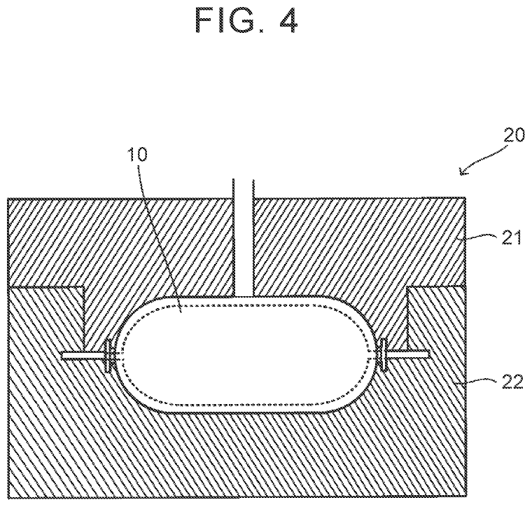

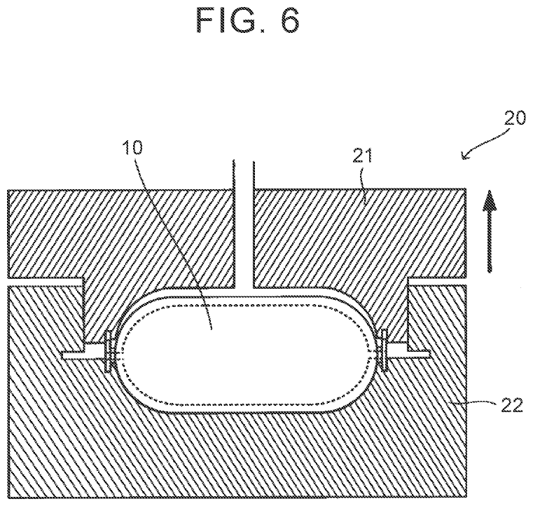

Further, the upper mold 21 can move relative to the lower mold 22, as shown by a straight arrow in FIG. 1B. Thus, in addition to the preform 10 being able to be installed on the mold 20 and separated from the mold 20, the upper mold can be moved to apply pressure on the preform 10 and can be moved to unload the applied pressure. More specifically, the mold 20 can be in an open state, a fastened state, and an unloading state as follows. The open state is a state in which the upper mold 21 is completely separated from the lower mold 22 and the upper surface of the lower mold 22 is completely exposed and opened (not shown). In this state, the preform 10 is installed on the lower mold 22 and the preform 10 is released from the mold 20 after impregnation. The fastened state is a state in which the preform 10 is installed in the mold 20, and the upper mold 21 and the lower mold 22 are completely connected and fastened (see FIGS. 1B and 4). Even in this fastened state, it is preferable that a slight gap is formed between the fiber layer 12 of the preform 10 before impregnation and the surfaces of the upper mold 21 and the lower mold 22. This gap takes into consideration that the volume of the fiber layer 12 after impregnation becomes larger than the volume before impregnation due to the impregnation of the resin composition. This gap between the upper mold 21 and the preform 10 is the same as the gap between the lower mold 22 and the preform 10. The unloading state is a state in which the preform 10 is installed in the mold 20, and the upper mold 21 and the lower mold 22 are slightly separated from each other than in the fastened state (see FIG. 6). The unloading state is achieved, for example, by slightly raising the upper mold 21 with respect to the fastened state. At this time, the gap between the upper mold 21 and the preform 10 is larger than the gap between the lower mold 22 and the preform 10. Even in this unloading state, the sealed state is maintained such that the resin composition for impregnation supplied inside does not leak out of the mold 20.

Further, the upper mold 21 is provided with a flow path 21a that reaches from the outside to the fiber layer 12 of the installed preform 10. By passing the resin composition through the flow path 21a, the resin composition is supplied to the fiber layer 12 and impregnated. Further, the mold 20 is also provided with an air flow passage for evacuating (vacuum deaeration) the formed internal space.

Further, the mold 20 is configured such that the temperature can be maintained at a desired temperature by a temperature control device (not shown).

Although the material used for the mold 20 is not particularly limited, a metal is preferably used, as usual, and the mold 20 is a so-called metal mold.

Impregnation Device

The impregnation device 30 is a device that supplies the resin composition, which is to be impregnated, to the mold 20 in which the preform 10 is installed. As can be seen from FIG. 2, the impregnation device 30 of the present embodiment includes a main agent tank 31, a main agent pump 32, a first curing agent tank 33, a second curing agent tank 34, a switching valve 35, a curing agent pump 36, and a mixer 37.

The main agent tank 31 is a tank in which the main agent of the composition to be impregnated is stored. The main agent will be described later. The main agent pump 32 is a pump that supplies the main agent stored in the main agent tank 31 to the mixer 37. Thus, the main agent tank 31 and the pump 32 are connected by piping, and the main agent pump 32 and the mixer 37 are connected by piping.

The first curing agent tank 33 is a tank in which the first curing agent is stored, and the second curing agent tank 34 is a tank in which the second curing agent is stored. Each curing agent will be described later. The switching valve 35 is connected to the first curing agent tank 33, the second curing agent tank 34, and the curing agent pump 36, and is configured to be able to switch the type of curing agent supplied to the mixer 37 by the curing agent pump 36. Therefore, the first curing agent tank 33 and the switching valve 35 are connected by piping, the second curing agent tank 34 and the switching valve 35 are connected by piping, and the switching valve 35 and the curing agent pump are connected by piping. The curing agent pump 36 and the mixer 37 are connected by piping.

The mixer 37 is a device that mixes the supplied main agent and curing agent and sends the resin composition formed by mixing to the mold 20. Specifically, the mixer 37 is connected to the flow path 21a of the mold 20 (see FIGS. 1A and 1B) by piping, and the sent resin composition passes through the piping and enters the flow path 21a of the mold 20. As described above, since the flow path 21a is connected to the fiber layer 12 of the installed preform 10, the resin composition passes through the flow path 21a and the resin composition is supplied to the fiber layer 12 to be impregnated.

Manufacturing Method of Fiber Reinforced Resin Molded Product

Next, a method for manufacturing a fiber reinforced resin molded product will be described. Here, for the sake of clarity, a high-pressure tank is given as a preferable example of the fiber reinforced resin molded product, and the mold and the impregnation device will be described using the mold 20 and the impregnation device 30. However, the present disclosure is not limited to the use of the mold 20 and the impregnation device 30.

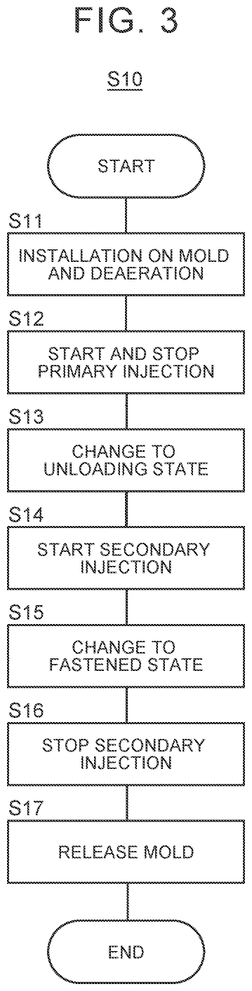

FIG. 3 shows the flow of a fiber reinforced resin molded product manufacturing method S10 according to one example. As can be seen from FIG. 3, the fiber reinforced resin molded product manufacturing method S10 according to the present embodiment includes a step S11 of installation in the mold and deaeration, a step S12 of starting and stopping a primary injection, a step S13 of changing to the unloading state, a step S14 of starting a secondary injection, a step S15 of changing to a fastened state, a step S16 of stopping the secondary injection, and a step S17 of releasing the product from the mold. Hereinafter, each step will be described.

Step S11 of Installation in Mold and Deaeration

In step S11 of installation in the mold and deaeration (may be referred to as “step S11”), as shown in FIG. 4, the preform 10 is installed in the mold 20 and is deaerated by evacuating. By this deaeration, the impregnated resin composition easily permeates into the fiber layer 12, and the impregnation is performed more smoothly.

More specifically, in the present embodiment, the mold 20 is in the open state and the preform 10 is installed on the lower mold 22 in which the upper surface is largely exposed, and then the upper mold 21 is disposed so as to cover the lower mold 22 and the preform 10 installed on the lower mold 22 to be in the fastened state. Then, the vacuum deaeration is performed by a vacuum pump. The vacuum deaeration is completed before a first resin composition is supplied to the fiber layer 12, which is carried out in the next step.

Step S12 of Starting and Stopping Primary Injection

In step S12 of starting and stopping the primary injection (may be referred to as “step S12”), the first resin composition in which the main agent and the first curing agent are mixed is supplied to the fiber layer 12 and the supply is stopped thereafter.

Main Agent

The main agent is a material capable of strengthening the fiber layer by being impregnated in the fiber layer 12 and by being cured, and to that extent an appropriate material can be used. In the present embodiment, the main agent is an epoxy resin, but other examples include polyurethane resin, phenol resin, and melamine resin.

First Curing Agent and First Resin Composition

The first curing agent is a material that cures the main agent by being mixed with the main agent. The first curing agent is mixed with the main agent to become the first resin composition. Thus, in the present embodiment, the first curing agent is composed of a material capable of curing the epoxy resin. However, for the first curing agent, a curing agent is used with which the curing start temperature of the first resin composition is higher than the curing start temperature of the second resin composition described later, and preferably the curing start temperature of the first resin composition be higher than the temperature of the mold 20. That is, the first resin composition takes a long time to cure, and is configured to be able to maintain fluidity until it reaches the layer of the fiber layer 12 in contact with the liner 11. Here, the “curing start temperature” means the temperature at which the polymerization reaction starts and a rapid temperature rise occurs.

The type of the first curing agent is not particularly limited as long as it can be the first resin composition satisfying the above, and examples thereof include aromatic polyamines such as dicyandiamide and metaphenylenediamine.

Although the supply amount of the first resin composition is not particularly limited, it is preferable that the supply amount be equal to or more than 50% by mass and equal to or less than 67% by mass with respect to the total amount of the first resin composition and the second resin composition. If the supply amount of the first resin composition is less than 50% by mass, there is a possibility that the amount of the first resin composition reaching the layer of the fiber layer 12 on the liner 11 side is small, and if the amount of the first resin composition is more than 67% by mass, there is a possibility that the time until the outer layer hardens, which is required to be release from the mold, becomes long, which may affect the productivity. The supply of the first resin composition is stopped when the determined supply amount is supplied.

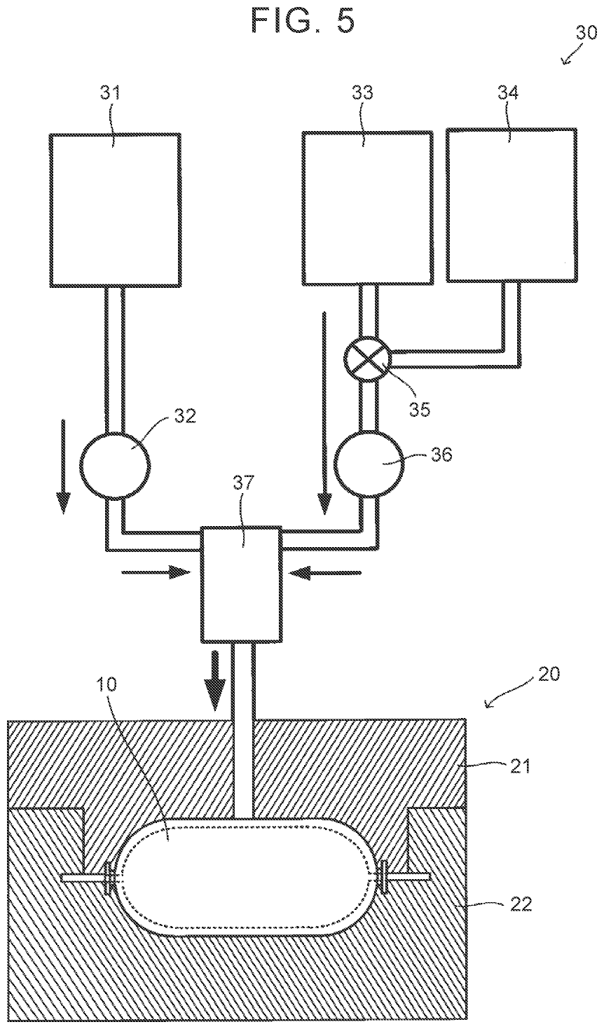

Specifically, in the present embodiment, as shown in FIG. 5, the main agent stored in the main agent tank 31 is supplied to the mixer 37 by the main agent pump 32. In contrast, the first curing agent stored in the first curing agent tank 33 passes through the switching valve 35 and is supplied to the mixer 37 by the curing agent pump 36. At this time, the switching valve 35 opens the flow path of piping from the first curing agent tank 33 and shuts off the flow path of the piping from the second curing agent tank 34. In the mixer 37, the supplied main agent and the first curing agent are mixed to form the first resin composition, and the mixer 37 supplies the produced first resin composition to the flow path 21a of the mold 20. The supplied first resin composition reaches the outer peripheral portion of the fiber layer 12 of the preform 10 installed in the mold 20 and is further impregnated by being permeated into the fiber layer. At this time, in the present embodiment, the temperature of the mold 20 is set lower than the curing start temperature of the first resin composition. How low the temperature is set is not particularly limited, and can be determined by taking into consideration the shortest time during which the first resin composition can reach the layer of the fiber layer 12 in contact with the liner 11 and the time required for curing.

As described above, in this step, the temperature is adjusted and the curing agent is used such that the fluidity is not lost until the first resin composition reaches the innermost layer side of the fiber layer (the layer opposite of the fiber layer from the outer layer side to which the first resin composition is supplied). As a result, even when the fiber layer is thick, the resin is more surely impregnated to the inner layer side of the fiber layer. Further, since the high fluidity can be maintained for a long time when the first resin composition is impregnated, the injection pressure at the time of impregnation can be kept low and thus, the equipment can be downsized and the cost can be lowered.

Step S13 of Changing to Unloading State

In step S13 of changing to the unloading state (may be referred to as “step S13”), after the primary injection is stopped in step S12, the upper mold 21 and the lower mold 22 are moved to be slightly separated, the state is changed to the unloading state, the force for pressing the preform 10 is relaxed, and a slight gap is provided between the upper mold 21 and the preform 10. The magnitude of the gap is not particularly limited, but may be about 10% of the thickness of the fiber layer. In the present embodiment, as shown by the straight arrow in FIG. 6, the upper mold 21 is raised to change the state to this unloading state.

Step S14 of Starting Secondary Injection

In step S14 of starting the secondary injection (may be referred to as “step S14”), the second resin composition in which the main agent and the second curing agent are mixed is supplied to the mold 20 in the unloading state.

Main Agent

The main agent is a material capable of strengthening the fiber layer by being impregnated in the fiber layer 12 and by being cured, and to that extent an appropriate material can be used. In the present embodiment, it is the same epoxy resin as the main agent of the first resin composition. By making the main agent of the first resin composition and the main agent of the second resin composition the same, the difference in physical properties can be reduced and thus, problems of performance such as strength and delamination become less likely to occur. However, if there is no problem with such performance, the use of a different main agent is not prevented.

Second Curing Agent and Second Resin Composition

The second curing agent is a material that cures the main agent by being mixed with the main agent. A second resin composition is obtained by the second curing agent being mixed with the main agent. Thus, in the present embodiment, the second curing agent is configured of a material capable of curing the epoxy resin. However, for the second curing agent, a curing agent is used with which the curing start temperature of the second resin composition is lower than the curing start temperature of the first resin composition described above, and preferably the curing start temperature of the second resin composition be lower than the temperature of the mold 20. That is, the second resin composition is configured to take a shorter time to cure than the first resin composition, and permeate in the fiber layer 12 to a certain extent such that the outer layer, which is on the opposite side of the fiber layer 12 from the layer in contact with the liner 11, is cured in a short time. Here, the “curing start temperature” is as described above.

The type of the second curing agent is not particularly limited as long as it can form the second resin composition satisfying the above, and examples thereof include aliphatic polyamines such as xylene diamine and diethylenetriamine.

The supply amount of the second resin composition is determined by the supply amount of the first resin composition.

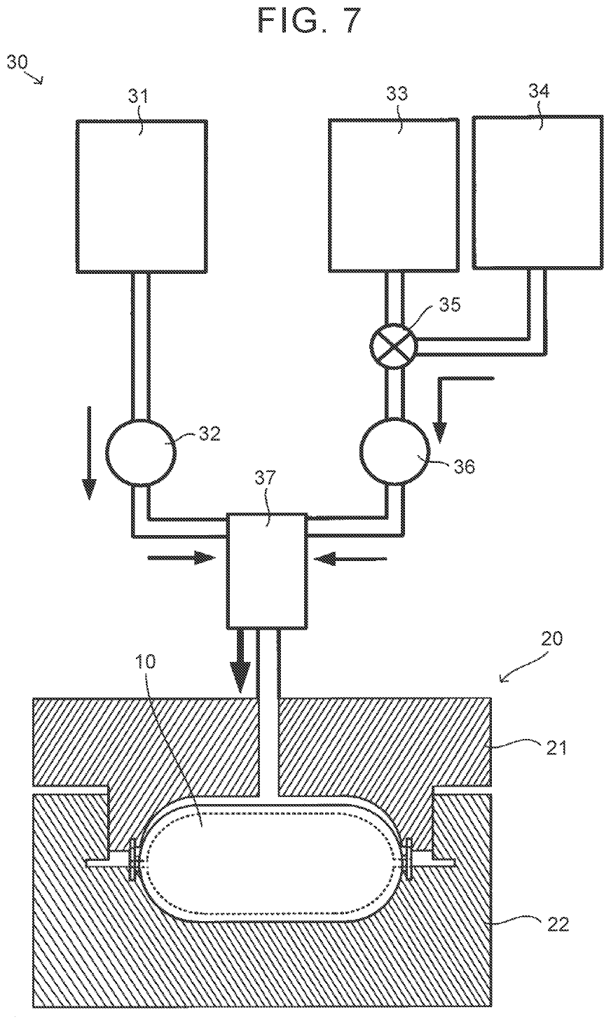

Specifically, in the present embodiment, as shown in FIG. 7, the main agent stored in the main agent tank 31 is supplied to the mixer 37 by the main agent pump 32. In contrast, the second curing agent stored in the second curing agent tank 34 passes through the switching valve 35 and is supplied to the mixer 37 by the curing agent pump 36. At this time, the switching valve 35 opens the flow path of piping from the second curing agent tank 34 and shuts off the flow path of piping from the first curing agent tank 33. In the mixer 37, the main agent and the second curing agent that are supplied are mixed to form the second resin composition, and the mixer 37 supplies the produced second resin composition to the flow path 21a of the mold 20. The second resin composition that is supplied reaches the outer peripheral portion of the fiber layer 12 of the preform 10 installed in the mold 20. At this time, the mold 20 is in the unloading state by step S13, the pressure on the preform 10 by the mold 20 is suppressed, and a gap is formed between the upper mold 21 and the preform 10. Thus, the resistance can be suppressed when the second resin composition flows. Therefore, the whole space between the upper mold 21 and the preform 10 is filled smoothly with the second resin composition that is supplied. Further, in the present embodiment, the temperature of the mold 20 is set higher than the curing start temperature of the second resin composition. How high the temperature is set is not particularly limited, and can be determined in consideration of the shortest time required for the second resin composition to permeate into the required fiber layer and the time required for curing.

Step S15 of Changing to Fastened State

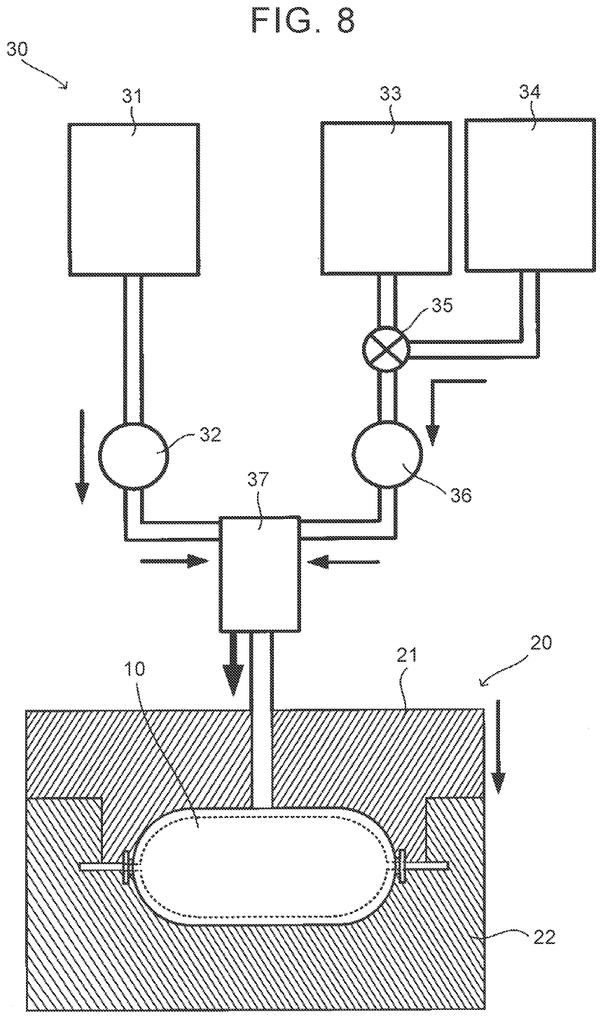

In step S15 of changing to the fastened state (may be referred to as “step S15”), the upper mold 21 and the lower mold 22 are moved so as to be close to each other, and the mold is brought into the fastened state. As a result, the pressure that the second resin composition receives from the mold 20 is increased, the impregnation of the second resin composition is promoted, the second resin composition positioned near the outer surface of the fiber layer 12 is leveled, and the surface becomes smooth. In the present embodiment, as shown in FIG. 8, the upper mold 21 is brought closer to the lower mold 22.

Step S16 of Stopping Secondary Injection

In step S16 of stopping the secondary injection (may be referred to as “step S16”), when the state is changed to the fastened state in step S15, the fiber layer is sufficiently impregnated with the second resin composition, and a desired supply amount is obtained, the supply of the second resin composition is stopped. Then, the process waits for the second resin composition to be cured. In the present disclosure, by supplying the second resin composition described above as the secondary injection, the curing of the outer layer side required for releasing the mold can be accelerated and thus, the productivity can be improved. Further, since the second resin composition cures quickly, the heat associated with the reaction tends to be high, and this heat can accelerate the curing of the first resin composition impregnated in advance, and the curing of the whole impregnated resin can also be accelerated.

Step S17 of Mold Release

In step S17 of mold release (may be referred to as “step S17”), following that at least the second resin composition is cured in the step S16, and the resin composition on the outer layer side of the fiber layer 12 is cured, the preform 10 impregnated with resin is separated from the mold 20. In the present embodiment, the upper mold 21 of the mold 20 is separated from the lower mold 22 to open the mold 20 for mold release.

Effects and Others

The preform 10 impregnated with resin can be obtained by the manufacturing method including each of the above steps, the mold for such a purpose, and the impregnation device. A high-pressure tank can be formed by further forming a layer of glass fibers impregnated with resin on the preform 10 impregnated with resin. According to the present disclosure, when the fiber layer is impregnated with resin by the RTM impregnation technique, a plurality of types of resin compositions having different curing start temperatures are used in order. Specifically, the first resin composition having a slower curing rate is used on the inner layer side, whereas the second resin composition having a faster curing rate is used on the outer layer side for impregnation. Thus, even if the fiber layer is thick, the first resin composition can be impregnated to the inner layer side, such that appropriate impregnation is performed. In contrast, since the second resin composition is impregnated on the outer layer side, the outer layer side can be rapidly cured and released from the mold. Further, the heat generated during the curing of the second resin composition accelerates the curing of the first resin composition. As a result, both homogeneous impregnation and high-speed curing required for mold release can be achieved, and cost reduction by improving productivity and high performance and high quality by homogeneous impregnation can be realized at the same time.

In the above, both the first resin composition and the second resin composition use a composition that starts curing by mixing a main agent and a curing agent. However, the present disclosure is not limited to this, and resin that is cured by heating or other methods may be used. However, since the main agent can be made of the same material by using a composition in which curing is started by the main agent and the curing agent being mixed, for both the first resin composition and the second resin composition, it is possible to keep the difference in physical properties between the inner layer side and the outer layer side small, and the strength can be increased.

What is claimed is:

1. A manufacturing method of a fiber reinforced resin molded product including impregnating a fiber layer with resin, the manufacturing method comprising:
supplying a first resin composition to the fiber layer; and
supplying a second resin composition to the fiber layer, after supplying the first resin composition to the fiber layer,
wherein a curing start temperature of the first resin composition is higher than a curing start temperature of the second resin composition.

2. The manufacturing method according to claim 1, wherein:
a mold is used for impregnating the fiber layer with the resin; and
a temperature of the mold is set lower than the curing start temperature of the first resin composition and higher than the curing start temperature of the second resin composition.

3. The manufacturing method according to claim 1, wherein a supply amount of the first resin composition is 50% by mass or more and 67% by mass or less with respect to a total supply amount of the first resin composition and the second resin composition.

4. The manufacturing method according to claim 1, wherein in both the first resin composition and the second resin composition, curing is started by a main agent and a curing agent being mixed, and the main agent of the first resin composition and the second resin composition is the same material.
